(19) United States
(12) Patent Application Publication
(10) Pub. No.: US 2026/0310205 A1
(43) Pub. Date: Oct. 8, 2026

(54) METHOD AND SYSTEM FOR CREATING VIRTUAL META MAP USING SPATIAL DATA ACQUIRED BY INTELLIGENT INDOOR AUTONOMOUS MOBILE ROBOT

(71) Applicant: INTEGRIT INC., Seoul (KR)

(72) Inventor: Dae Yun LEE, Seoul (KR)

(73) Assignee: INTEGRIT INC., Seoul (KR)

(21) Appl. No.: 19/152,496

(22) PCT Filed: May 17, 2023
(86) PCT No.: PCT/KR2023/006706

§ 371 Date: Jul. 31, 2025

(30) Foreign Application Priority Data
May 18, 2022 (KR) 10-2022-0061085
Apr. 14, 2023 (KR) 10-2023-0049372

(51) Int. Cl. G05D 1/246; G01C 21/00; G01C 21/20

(52) U.S. Cl. CPC G05D 1/2465; G01C 21/206; G01C 21/383

(57) ABSTRACT

A system for creating a virtual meta map using spatial data acquired by an intelligent indoor autonomous mobile robot, includes: an autonomous mobile robot or mobility which transmits location information about a target object located in an indoor space, the location information being acquired by a visualization sensor while the robot or mobility travels autonomously; and a cloud server which generates, in advance, a virtual map containing object information about the autonomous mobile robot, displays the autonomous mobile robot or mobility and the location information of the target object within the virtual space, generates a meta map reflecting driving commands for guiding the autonomous mobile robot or mobility to the target object within the virtual space, and then converts a virtual space coordinate system in the meta map to a real-life coordinate system and provides the real-life coordinate system to the autonomous mobile robot or mobility.

### TECHNICAL FIELD

The present invention relates to a method and system for creating a virtualized meta-map using spatial data acquired by an intelligent indoor autonomous mobile robot.

### BACKGROUND ART

Three-dimensional (3D) spatial information technology, which is the basic technology of 3D geographic information systems (GISs), refers to information technology for expressing two-dimensional (2D) location information similarly to the real world by adding height (depth), image, attributes, etc., to the 2D location information.

The core of this 3D spatial information technology is to generate a 3D electronic map and embed all relevant information therein, laying the foundation for the public sector and related industries such as ubiquitous (U)-city, telematics, location-based service (LBS), urban planning and development, disaster prevention, traffic control, environment, etc.

These days, it is very common to use a map service through a vehicle navigation device, a portable terminal, etc., to move to a specific location. As a map service, 2D map services for providing buildings, roads, etc., in a 2D flat format have been common, but recently, 3D map services have emerged. These 3D map services are becoming increasingly useful as they equally replicate the real world, and web-based 3D map services that are accessible at any place are currently being provided in many countries and companies.

Therefore, the present invention discloses a method and system for creating a virtualized meta-map using spatial data acquired by an intelligent indoor autonomous mobile robot.

### RELATED ART DOCUMENT

Korean Patent No. 10-2242834

### DISCLOSURE

### Technical Problem

An object of embodiments of the present invention is to provide a method and system for creating a virtualized meta-map using spatial data acquired by an intelligent indoor autonomous mobile robot that can address conventional issues.

### Technical Solution

A system for creating a virtualized meta-map using spatial data acquired by an intelligent indoor autonomous mobile robot according to an embodiment of the present invention includes an autonomous mobile robot or mobility configured to transmit position information of a target object in an indoor space acquired using a visualization sensor during an autonomous travel process and a cloud server configured to generate, in advance, a virtualized map including object information of the autonomous mobile robot to which overall landscape and object information of the indoor space are mapped, display the autonomous mobile robot or mobility and position information of the target object in a virtual space, generate a meta-map reflecting a travel instruction for the autonomous mobile robot or mobility to move to the target object in the virtual space, and then convert a virtual space coordinate system in the meta-map into a real-world coordinate system and provide information obtained by converting the virtual space coordinate system in the indoor space into the real-world coordinate system to the autonomous mobile robot or mobility, wherein the autonomous mobile robot or mobility moves to the target object in the indoor space on the basis of the information.

The cloud server may include an information collection unit configured to collect position information and feature information of a person and/or an object measured during the autonomous travel process of the autonomous mobile robot or mobility and real-world coordinate information of the indoor space in which the autonomous mobile robot or mobility travels from an external server, a virtual space modeling unit configured to model a 3D virtual space on indoor coordinates of the indoor space using a digital twin technique, a travel information agent unit configured to provide the travel instruction for an avatar of the autonomous mobile robot or mobility which is an agent in the virtual space to move to the target object, and a meta-map generation unit configured to generate a meta-map including the travel instruction for the avatar of the autonomous mobile robot or mobility to move to the target object in the virtual space.

The meta-map generation unit may include a mapping unit configured to generate a mapping map in which spatial coordinates of the virtual space which is a digital twin space (DTS) generated by the virtual space modeling unit are mapped to spatial coordinates of a real world, a synchronization unit configured to synchronize position information of the autonomous mobile robot or mobility in the real world on the mapping map with a position of an avatar of the autonomous mobile robot or mobility in the virtual space, a target object designation unit configured to designate or generate the target object at a position designated by an external terminal in the mapping map, a movement route generation unit configured to calculate a movement route from the position of the autonomous mobile robot or mobility to the target object in the mapping map and provide the calculated movement route, and a meta-map provision and update unit configured to generate a meta-map reflecting the movement route generated by the movement route generation unit and reflecting the travel instruction provided by the travel information agent unit in the movement route and transmit the meta-map to the autonomous mobile robot or mobility in the real world. The meta-map provision and update unit may update the existing meta-map with a meta-map in which a movement route to the target object is recalculated by reflecting detection information, which is obtained by detecting an obstacle (moving object) while the autonomous mobile robot or mobility moves along the movement route displayed on the meta-map, in real time and provide the updated meta-map.

### Advantageous Effects

When a system and method for creating a virtualized meta-map using spatial data acquired by an intelligent indoor autonomous mobile robot according to an embodiment of the present invention are used, it is possible to remotely control an autonomous mobile robot or mobility by applying movement of a digital object caused by a manipulation command in a virtual space to the real world.

In addition, it is possible to apply an event acquired from an autonomous mobile robot or mobility to a virtual space and create a meta-map reflecting the event.

### DESCRIPTION OF DRAWINGS

FIG. 1A is a diagram showing an architecture of a digital twin, and FIG. 1B is a diagram showing an architecture of a metaverse.

FIG. 2 is a diagram showing a network configuration of a system for creating a virtualized meta-map using spatial data acquired by an intelligent indoor autonomous mobile robot according to an embodiment of the present invention.

FIG. 3 is a diagram showing a detailed configuration of an autonomous mobile robot or mobility shown in FIG. 2.

FIG. 4 is a diagram showing a detailed configuration of a cloud server shown in FIG. 2.

FIG. 5 is a diagram showing a detailed configuration of a meta-map generation unit shown in FIG. 4.

FIG. 6 is an example diagram showing a meta-map converted into real-world coordinates supported by the cloud server shown in FIG. 2 and a process of converting real-world coordinates into virtual-space coordinates.

FIG. 7 is a diagram showing an exemplary computing environment in which one or more embodiments disclosed in the present specification can be implemented.

### MODES OF THE INVENTION

Hereinafter, embodiments of the present invention will be described in detail such that those of ordinary skill in the art to which the present invention pertains can readily implement the present invention with reference to the accompanying drawings.

However, the present invention may be implemented in various different forms and is not limited to embodiments described herein. In the drawings, parts not relevant to the description are omitted to clearly describe the present invention, and like reference numerals refer to like parts throughout the specification.

Throughout the specification, when any one part is referred to as being “connected to” another part, the parts may be “directly connected” to each other or may be “electrically connected” to each other with still another part interposed therebetween. Also, when a certain part is referred to as “including” a certain component, other components are not excluded and may be further included unless otherwise described, and it should be understood that it does not preclude the possibility of addition or presence of one or more other features, numbers, steps, operations, components, parts, or combinations thereof.

The terms “about,” substantially,” etc., used throughout the specification mean figures corresponding to manufacturing and material tolerances specific to stated meanings or figures close thereto, and are used to prevent unconscionable abusers from unfairly using the disclosure of figures precisely or absolutely described to aid the understanding of the present invention. The term “operation” or “operation of” used throughout the specification of the present invention does not mean “operation for.”

In the present specification, the term “unit” includes a unit implemented by hardware, a unit implemented by software, and a unit implemented by both hardware and software. Further, one unit may be implemented by two or more pieces of hardware, and two or more units may be implemented by one piece of hardware. However, a “unit” is not limited to software or hardware and may be configured to be in an addressable storage medium or configured to operate one or more processors.

Therefore, as an example, a “unit” includes components such as software components, object-oriented software components, class components, and task components, processes, functions, attributes, procedures, subroutines, segments of program code, drivers, firmware, microcode, circuits, data, databases, data structures, tables, arrays, and variables. Components and functions provided in “units” may be combined into a smaller number of components and “units” or may be subdivided into additional components and “units.” Moreover, components and “units” may be implemented to operate one or more central processing units (CPUs) in a device or a secure multimedia card.

In the present specification, some operations or functions described as being performed by a terminal, an apparatus, or a device may be performed instead in a server connected to the terminal, apparatus, or device. Similarly, some operations or functions described as being performed by a server may be performed in a terminal, an apparatus, or a device connected to the server.

In the present specification, some operations or functions described as mapping with or matching a terminal may be construed as mapping or matching a unique number of the terminal, which is identification data of the terminal, or personal identification information.

Hereinafter, a system and method for creating a virtualized meta-map using spatial data acquired by an intelligent indoor autonomous mobile robot according to an embodiment of the present invention will be described in detail with reference to the accompanying drawings.

First, the difference between a digital twin and a metaverse mentioned herein will be briefly described before the present invention.

A digital twin and a metaverse are similar in the sense that they are implemented through virtual worlds, but they differ in how the real world is viewed. Digital twins correspond to a technology for implementing objects, such as a city, a machine, a factory, etc., of the real world in a virtual world and operating the virtual world in the same way as the real world on the basis of the objects.

Since a reality is implemented like a twin in a virtual world, the technology is referred to as digital twin technology.

As a simple example, in screen golf, the act of swinging a club to hit a ball is performed in the real world, but the ball flies and scores points in a virtual world.

Digital twins of the early stage simply replicate the real world in virtual worlds, but recent advances in Internet of things (IoT), computing, artificial intelligence (AI) technologies, etc., have made it possible to virtually simulate various scenarios that are impossible to simulate due to real-world constraints.

Rather than simply predicting results, it is possible to make realistic predictions and respond to problems in real time on the basis of various sensors, real-world data, etc.

In practice, Predix, utilized by General Electronics (GE), is a cloud platform for integrating GE's equipment and software with the industrial Internet to support smart factories. Predix is utilized to safely collect and analyze data from a variety of machines and equipment. Predix is a digital twin platform for efficiently running equipment in the real world on the basis of the results.

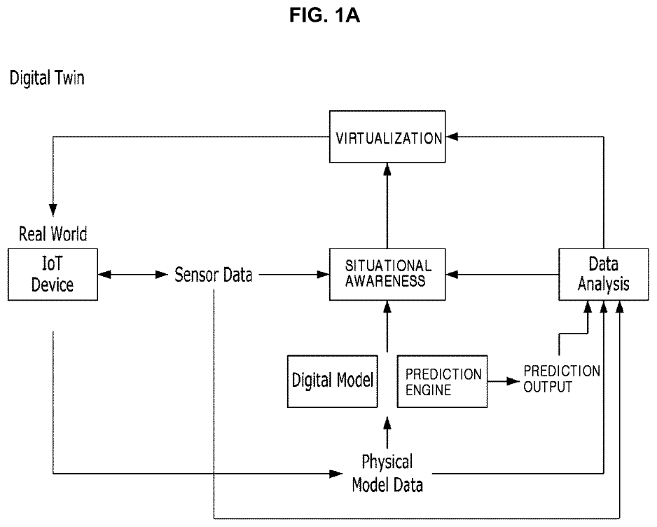

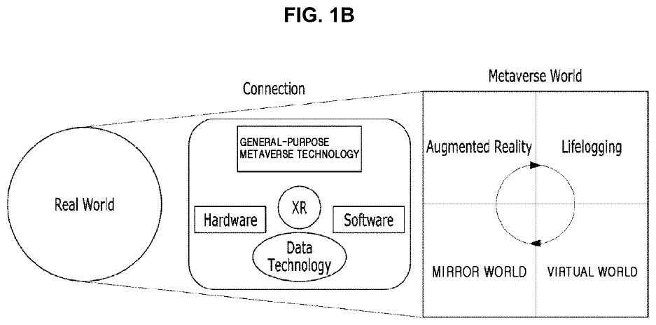

FIG. 1A is a diagram showing a structure of a digital twin that generates a digital model from a real-world object on the basis of model data and data collected using a sensor in the real world and implement data analysis and prediction and situational awareness through visualization in the real world.

The term “metaverse” is a compound word of “meta” which means transcendence and “universe” which means the real world. A metaverse enables a user to experience various virtual worlds using an avatar of the user, but does not mean that a virtual world is implemented from the real world, which is different from a digital twin. A metaverse is no longer confined to an initial 3D virtual world and intersects with reality, allowing the production and sharing of various experiences and values through interactions between a virtual world and the real world.

Zepeto, a metaverse platform operated by NAVER, is a platform that implements avatars and virtual worlds on the basis of facial recognition and augmented reality.

Zepeto is operated on the basis of maps which are virtual worlds, Build-it for creating a map, and Zepeto studio for creating outfits for avatars. Users may use his or her avatar to directly communicate with other avatars in various virtual spaces. In addition, the boy group BTS even announced their new song as a concert inside the game Fortnite.

Mesh, Microsoft's remote collaboration platform, is a metaverse platform based on mixed reality (MR) that allows users from different regions to feel like they are working in the same space through avatars.

Like this, metaverses are expanding into other realms such as games, industries, and even everyday life such as gatherings and shopping. In the future, the convergence of more and more areas and activities in the real world with virtual worlds will accelerate. FIG. 1B is a conceptual diagram of a metaverse that connects the real world to a virtual world using four elements including augmented reality of the metaverse, mirror world implemented by adding additional information to the physical world, lifelogging for virtually reproducing information, such as emotions, movements, body, etc., that humans experience, and a virtual world, and general-purpose metaverse technology such as extended reality (XR), data technology, etc.

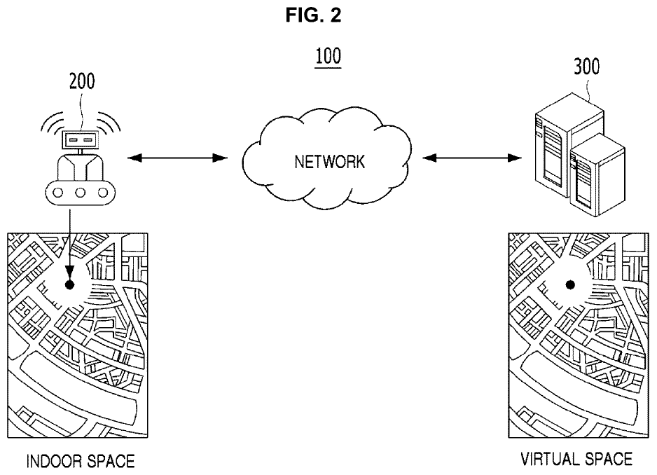

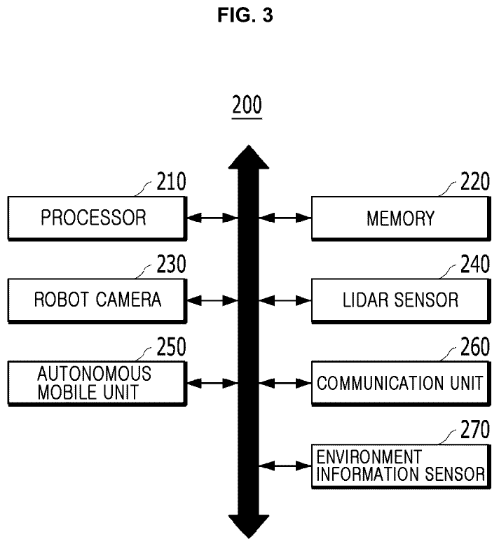

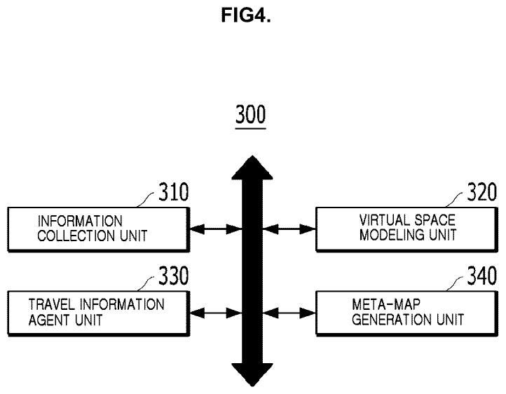

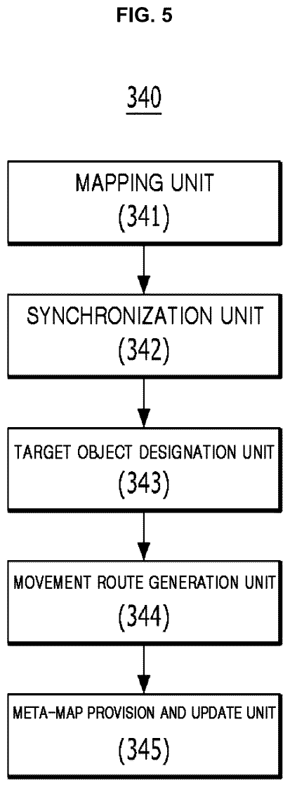

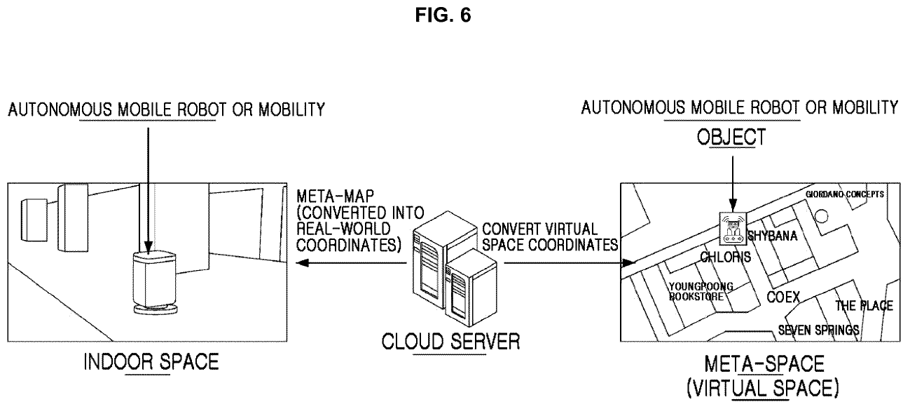

FIG. 2 is a diagram showing a network configuration of a system for creating a virtualized meta-map using spatial data acquired by an intelligent indoor autonomous mobile robot according to an embodiment of the present invention. FIG. 3 is a diagram showing a detailed configuration of an autonomous mobile robot or mobility shown in FIG. 2. FIG. 4 is a diagram showing a detailed configuration of a cloud server shown in FIG. 2. FIG. 5 is a diagram showing a detailed configuration of a meta-map generation unit shown in FIG. 4. FIG. 6 is an example diagram showing a meta-map converted into real-world coordinates supported by the cloud server shown in FIG. 2 and a process of converting real-world coordinates into virtual-space coordinates.

First, as shown in FIG. 2, a system 100 for creating a virtualized meta-map using spatial data acquired by an intelligent indoor autonomous mobile robot according to an embodiment of the present invention includes an autonomous mobile robot or mobility 200 and a cloud server 300.

Here, each component communicates via a network, and the network means a connection structure in which nodes such as a plurality of terminals and servers can exchange information. Examples of a network may include any one or more of a personal area network (PAN), a local area network (LAN), a campus area network (CAN), a metropolitan area network (MAN), a wide area network (WAN), a broadband network (BBN), the Internet, etc. In addition, the network may include, but is not limited to, any one or more of network topologies including a bus network, a star network, a ring network, a mesh network, a star-bus network, a tree or hierarchical network, etc.

In the following, the term “at least one” is defined as a term including the singular and plural, and even when the term “at least one” does not exist, each component may exist in either the singular or plural and refer to the singular or plural. In addition, each component may be provided in the singular or plural depending on embodiments.

The plurality of autonomous mobile robots or mobilities 200 may be intended to collect feature information of people and/or objects while traveling designated different indoor spaces.

In addition, the plurality of autonomous mobile robots or mobilities 200 may perform, along a designated movement route, various operations including obstacle detection and avoidance, recognition of environmental information such as temperature, humidity, air conditions, etc., tracking, change detection, high-speed travel, video surveillance, blind spot determination, and the like.

Depending on embodiments, an autonomous mobile robot or mobility may be referred to by various terms such as mobile robot, a surveillance mobile robot, a surveillance robot, etc.

The autonomous mobile robot or mobility 200 includes a processor 210, a memory 220, a robot camera 230, a lidar sensor 240, an autonomous mobile unit 250, and a communication unit 260.

The processor 210 executes commands for controlling travel operations of the autonomous mobile robot or mobility 200 in accordance with an implementation order (manipulation information) in a meta-map provided by the cloud server 300 which will be described below.

Also, the processor 210 may extract or calculate feature information and spatial coordinate information of an object and/or person detected by the robot camera 230 and the lidar sensor 240 which will be described below.

Also, the processor 210 may detect a person and/or object in an indoor space using imaged information of the robot camera and a lidar signal detected by the lidar sensor and extract appearance features of the detected object and person using an object recognition model.

The object recognition model may be implemented using various algorithms such as a scale invariant feature transform (SIFT) algorithm, a histogram of oriented gradients (HOG) algorithm, a Haar algorithm, a Ferm algorithm, etc.

Also, the processor 210 may calculate a position, a density, etc., of the object and person in the indoor space on the basis of a position where the object and/or person is detected and a detection distance from the person and/or object.

Here, the density is determined on the basis of the number of pieces of lidar data distributed or located in a specific area, and an association between lidar data is determined on the basis of the Euclidean distance, a reflectance, a normal vector, etc., between the lidar data.

In other words, the processor 210 may determine lidar data that is distributed in similar areas and have similar attributes on the basis of the degree of distribution of the lidar data and similarity between the lidar data, and cluster the lidar data as a separate group.

Also, the processor 210 may process sensor data required for extracting feature data of the object and/or person and the feature data as an encrypted message and then store the message in a memory (buffer) which will be described below.

Also, the processor 210 may process messages stored in the memory (buffer) as one record through a worker thread and provide the messages.

The memory 220 may store the record processed by the processor 210.

Also, the memory 220 may be a space for storing various environment information (sound, etc.) collected during an autonomous travel.

Also, the memory 220 may store data and instructions (application programs) for operations of the autonomous mobile robot or mobility.

At least some of the application programs may be downloaded from an external server using wireless communication. The memory 220 may include at least one storage medium among a flash memory type, a hard disk type, a multimedia card micro type, a card type memory (e.g., a secure digital (SD) or extreme digital (XD) memory, etc.), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM).

The robot camera 230 may image the indoor space along the movement route. Captured images are used for the above-described processor to recognize or determine an object and/or a person and extract feature information (the face, body, gender, etc.) of a person.

The lidar sensor 240 may measure a position of an object and/or a person. For reference, the lidar sensor 240 can measure a position of an object in a space using a wide viewing angle over a long distance and thus is used for tracking its position within a limited area of space even when positions of some objects change.

For reference, the lidar sensor 240 externally emits light with the radar wavelength and measure a time that it takes for the emitted light to reflect off an external object and return, generating information about a position of an object and/or person (lidar data).

Meanwhile, the lidar sensor 240 of the present invention may be a 3D lidar sensor composed of a plurality of layers of 2D lidar sensors to determine not only whether there is an object (thing and person) but also a type of object using lidar data.

However, when a 2D lidar sensor is tilted or rotated, lidar data including 3D information may be acquired. Accordingly, the lidar sensor 240 used in the present invention may be implemented as a 2D lidar sensor configured to be tilted or rotated.

The autonomous mobile unit 250 can travel autonomously on a set course and includes a lidar sensor for detecting an obstacle, a satellite navigation autonomous driving algorithm, etc., therein. Since autonomous driving technologies are well known, detailed description thereof will be omitted.

The communication unit 260 performs bidirectional communication with a digital twin map creation server which will be described below, and is communicatively connected to any internal component or any at least one external terminal via a wired/wireless communication network.

The external terminal may include a server (not shown), another terminal (not shown), etc. Here, a wireless Internet technology may be wireless LAN (WLAN), Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Institute of Electrical and Electronics Engineers (IEEE) 802.16, Long Term Evolution (LTE), Long Term Evolution-Advanced (LTE-A), Wireless Mobile Broadband Service (WMBS), etc., and the communication unit transmits and receives data in accordance with at least one wireless Internet technology within a range including Internet technologies that are not listed above. Also, a short-range communication technology may be Bluetooth, radio frequency identification (RFID), Infrared Data Association (IrDA), Ultra-Wideband (UWB), ZigBee, Near Field Communication (NFC), Ultra Sound Communication (USC), Visible Light Communication (VLC), Wi-Fi, Wi-Fi direct, etc. Also, a wired communication technology may be Power Line Communication (PLC), Universal Serial Bus (USB) communication, Ethernet, serial communication, optical/coaxial cables, etc.

The communication unit 260 and any terminal may transmit information to each other using USB.

In addition, the communication unit 260 transmits and receives wireless signals to and from a base station, the server, the other terminal, etc., via a mobile communication network built in accordance with technology standards or communication methods (e.g., Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), HSDPA, HSUPA, LTE, LTE-A, etc.) for mobile communication.

The cloud server 300 may generate a virtual space to which coordinate information of the indoor space is mapped, display coordinate information of a target object in the virtual space, and generate a meta-map in which control information containing travel command information of the autonomous mobile robot or mobility is recorded, providing the meta-map to the autonomous mobile robot or mobility.

Also, the cloud server 300 may update the meta-map by reflecting, in the coordinates of the virtual space, position information of an obstacle or object detected in real time by the autonomous mobile robot or mobility traveling in the indoor space, and update a travel route to the target object and travel information in accordance with the position information of the obstacle or object.

Also, the cloud server 300 may generate, in advance, a virtualized map including object information of the autonomous mobile robot to which overall landscape and object information of the indoor space are mapped, display the autonomous mobile robot or mobility and the position information of the target object in the virtual space, generate a meta-map reflecting a travel instruction for the autonomous mobile robot or mobility to move to the target object in the virtual space, and then convert a virtual space coordinate system in the meta-map into a real-world coordinate system, providing information obtained by converting the virtual space coordinate system in the indoor space into the real-world coordinate system to the autonomous mobile robot or mobility.

More specifically, the cloud server 300 includes an information collection unit 310, a virtual space modeling unit 320, a travel information agent unit 330, and a meta-map generation unit 340.

The information collection unit 310 may collect measurement information measured by the previously registered autonomous mobile robot or mobility 200. Here, the measurement information may include position information and feature information of a person and/or an object measured during an autonomous travel process.

Also, the information collection unit 310 may collect real-world coordinate information of the indoor space in which the autonomous mobile robot or mobility travels from the external server.

The virtual space modeling unit 320 may model a 3D virtual space on indoor coordinates of the indoor space.

Here, the 3D virtual space which is a space in a virtual world may be configured in the form of a virtual space (VS), a mixed space (MS), and/or a digital twin space (DTS) depending on a feature of the space.

The VS may be a pure digital-based space, the DTS may be a virtual space based on the real world, and the MS may be a space in which a VS and a DTS are mixed.

The MS may be provided in a form in which the autonomous mobile robot or mobility is adapted to an environment of the real world or provided in a form in which an environment of the real world is rendered in the virtual world.

A space of the virtual world may be a basic virtual space where the autonomous mobile robot or mobility may move.

This space of the virtual world may be generated and utilized variously depending on a user.

Meanwhile, multiple agents may exist in the space of the virtual world, and the agents may represent users or programs in the space of the virtual world.

Here, an agent as a program may have the form of an artificial intelligence (AI) agent and may be a virtual avatar or persona present in place of a third-party service provider. A physical characteristic of the space of the virtual world to which the agent belongs may be applied to the agent, and a service profile set for the space of the virtual world may be applied to the agent.

Also, an agent may have a characteristic based on information on a physical device used by a user. For example, the agent may have a viewing angle based on a display characteristic of a physical display used by a user or may have a control characteristic based on a controller of the physical device.

In the space of the virtual world, various digital objects are present, and the digital objects are key elements constituting world information in the space of the virtual world and may collectively refer to objects that provide a mutual interaction function with agents.

Here, the digital objects may be formed in an object area (OA) that is an area included in the space of the virtual world.

Also, the digital objects may include a display object (DO), an interaction object (IO), a web object (WO), and a streaming object (SO).

Each of the DO, IO, WO, and SO may selectively include a display area for displaying content.

The virtual space generated by the virtual space modeling unit 320 may be a space in which a real-world environment including roads, buildings, and landmarks existing in the real world is equally projected to the virtual space.

The virtual space modeling unit 320 generates the virtual space by simulating a specific space on the basis of 3D information of the corresponding space using a digital twin technique.

For example, the 3D information of the specific space may be any one of a blueprint of the corresponding space, 3D scan data, a floor plan, and data generated by actually measuring the specific space.

The virtual space modeling unit 320 may calculate a difference between an initial position and an object in object detection data using a 3D model disposed in a digital twin and estimate geographical data including the position and angle of the object through optimization for minimizing the difference, realizing a DTS using the estimated geographical data.

A digital twin described in the present invention is used in various systems and industries, such as manufacturing, medical, transportation, aerospace, and construction systems or industries, and may be formed on the basis of IoT data, 3D objects, and a 3D geographic map using standardized data.

For reference, the digital twin technology is known as a technology for controlling real physical models, real sensor information, etc., by predicting a future phenomenon of a real physical model, a real sensor information model, etc., using a digital twin model that maintains the sameness and consistency with a real physical model, a real sensor information model, etc., that is dynamically interpretable in real time.

The virtual space generated by the virtual space modeling unit 320 is divided into grids with a certain size, and each grid is given address information and spatial information including unique coordinate values.

The travel information agent unit 330 may provide a travel instruction for an avatar of the autonomous mobile robot or mobility which is an agent in the virtual space to move to the target object.

Here, the travel instruction may be an instruction for a movement route, a movement speed, a movement direction, etc., from a current position to the target object in the virtual space.

Also, the travel information agent unit 330 may detect a person and/or object on the travel route in the indoor space in real time and provide a travel instruction obtained by modifying or correcting the movement route, the movement speed, and the movement direction to the target object in accordance with a position of the detected person and/or object.

The meta-map generation unit 340 generates a meta-map including the travel instruction for the autonomous mobile robot or mobility of the real world to move to the target object in the space of the virtual world configured in the form of the VS, the MS, and/or the DTS generated by the virtual space modeling unit 320.

The meta-map generated by the meta-map generation unit 340 is obtained by converting 3D coordinates of the virtual space into real-world coordinates that are recognizable by the autonomous mobile robot or mobility of the real world, and may include spatial data, feature information of an object and/or person, position information, etc., acquired by the autonomous mobile robot or mobility of the real world.

More specifically, the meta-map generation unit 340 includes a mapping unit 341, a synchronization unit 342, a target object designation unit 343, a movement route generation unit 344, and a meta-map provision and update unit 345.

The mapping unit 341 may generate a mapping map in which spatial coordinates of the virtual space which is a DTS generated by the virtual space modeling unit 320 and spatial coordinates of the real world are mapped to each other.

The synchronization unit 342 may synchronize position information of the autonomous mobile robot or mobility in the real world on the mapping map with a position of the avatar of the autonomous mobile robot or mobility in the virtual space.

The target object designation unit 343 may designate or generate the target object at a position designated by the external terminal in the mapping map.

The movement route generation unit 344 calculates a movement route from the position of the autonomous mobile robot or mobility to the target object in the mapping map and provide the calculated movement route.

For reference, when the autonomous mobile robot or mobility of the real world moving to along the calculated movement route detects an obstacle (a moving object, etc.) on the movement route, the movement route generation unit 344 recalculates and provides an additional movement route for avoiding the detected obstacle.

The meta-map provision and update unit 345 may generate a meta-map reflecting the movement route generated by the movement route generation unit 344 and reflecting the travel instruction provided by the travel information agent unit in the movement route and transmit the meta-map to the autonomous mobile robot or mobility in the real world.

The meta-map provision and update unit 345 may update the existing meta-map with a meta-map in which a movement route to the target object is recalculated to reflect detection information, which is obtained by detecting an obstacle (moving object) while the autonomous mobile robot or mobility moves along the movement route displayed on the meta-map, in real time and provide the updated meta-map.

FIG. 6 is a flowchart illustrating a method of creating a virtualized meta-map using spatial data acquired by an intelligent indoor autonomous mobile robot according to the embodiment of the present invention.

Referring to FIG. 6, a method S700 of creating a virtualized meta-map using spatial data acquired by an intelligent indoor autonomous mobile robot according to the embodiment of the present invention may include a process in which an autonomous mobile robot or mobility acquires indoor space information acquired by a visualization sensor and position data of a target object in the indoor space information (S710), analyzes features of the target object, calculates position coordinates, and provides the position coordinates to the cloud server (S720), the cloud server 300 generates a meta-map of a virtual space mapped to the indoor space (S730), displays the autonomous mobile robot and the position and feature information of the target object in the generated meta-map (S740), and provides a travel instruction for the autonomous mobile robot or mobility to travel to the target object in a virtualized map (space) (S750), coordinates in the meta-map in which the travel instruction is recorded are converted into a real-world coordinate system that is recognizable by the autonomous mobile robot or mobility (S760), and the autonomous mobile robot or mobility 200 executes the travel instruction in the meta-map.

The process S700 may further include an operation in which, when object information of a person and/or object is in a travel course, the autonomous mobile robot or mobility generates a new travel instruction to detour around the person and/or object and updates the travel course.

When a system and method for creating a virtualized meta-map using spatial data acquired by an intelligent indoor autonomous mobile robot according to the embodiment of the present invention are used, it is advantageously possible to remotely control an autonomous mobile robot or mobility by applying movement of a digital object caused by a manipulation command in a virtual space to the real world.

Also, it is possible to apply an event acquired from an autonomous mobile robot or mobility to a virtual space and create a meta-map reflecting the event.

In addition, a user (manager) can view a virtualized map to provide an instruction to manipulate and move a position of a robot and monitor the robot, and can convert position data of the virtualized map into a coordinate system that is actually recognized by the robot and provide the converted position data.

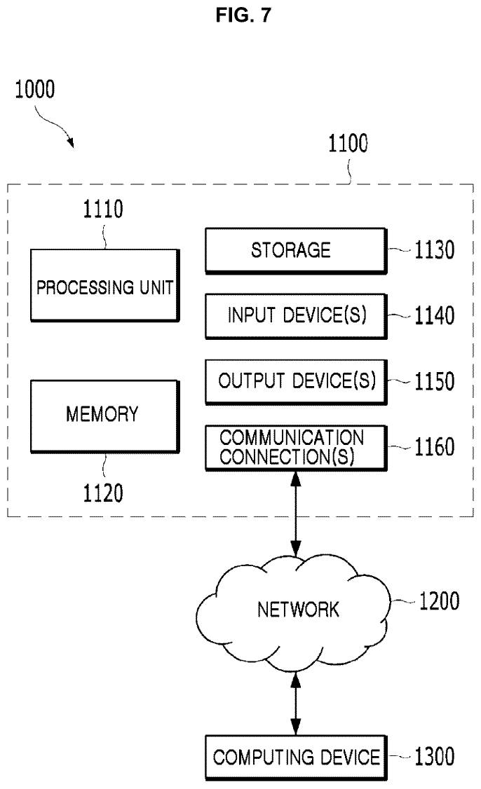

FIG. 7 is a diagram showing an exemplary computing environment in which one or more embodiments disclosed in the present specification can be implemented, that is, an example of a system 100 including a computing device 1100 configured to implement the one or more embodiments described above. For example, the computing device 1100 includes, but is not limited to, a personal computer, a server computer, a handheld or laptop device, a mobile device (a mobile phone, a personal digital assistant (PDA), a media player, etc.) a multiprocessor system, a consumer electronics, a mini computer, a mainframe computer, a distributed computing environment including any of the above-described systems or devices, etc.

The computing device 1100 may include at least one processing unit 1110 and a memory 1120. The processing unit 1110 may include, for example, a CPU, a graphics processing unit (GPU), a microprocessor, an application-specific integrated circuit (ASIC), a field programmable gate array (FPGA), etc., and may have a plurality of cores. The memory 1120 may be a volatile memory (e.g., a RAM, etc.), a non-volatile memory (e.g., a ROM, a flash memory, etc.), or a combination thereof. In addition, the computing device 1100 may include an additional storage 1130. The storage 1130 includes a magnetic storage, an optical storage, etc., but is not limited thereto. In the storage 1130, computer-readable commands for implementing one or more embodiments disclosed herein may be stored, and other computer-readable commands for executing an operating system (OS), application programs, etc., may also be stored. The computer-readable commands stored in the storage 1130 may be loaded into the memory 1120 for execution by the processing unit 1110. In addition, the computing device 1100 may include an input device(s) 1140 and an output device(s) 1150.

Here, the input device(s) 1140 may include, for example, a keyboard, a mouse, a pen, a voice input device, a touch input device, an infrared camera, a video input device, any other input device, etc. Also, the output device(s) 1150 may include, for example, at least one display, a speaker, a printer, any other output device, etc. In addition, the computing device 1100 may use an input device or output device provided in another computing device as the input device(s) 1140 or output device(s) 1150.

The computing device 1100 may include a communication connection(s) 1160 that enables the computing device 1100 to communicate with another device (e.g., a computing device 1300).

Here, the communication connection(s) 1160 may include a modem, a network interface card (NIC), an integrated network interface, a radio frequency transmitter/receiver, an infrared port, a USB connection, or another interface for connecting the computing device 1100 to another computing device. Also, the communication connection(s) 1160 may include a wired connection or a wireless connection. Each component of the computing device 1100 described above may be connected by various interconnections such as a bus (e.g., peripheral component interconnection (PCI), USB, firmware (IEEE 1394), an optical bus structure, etc.) or may be interconnected by a network 1200. Terns such as “component,” “system,” etc., used herein generally refer to computer-related entities that are hardware, a combination of hardware and software, software, or software in execution.

For example, a component may be a process executed on a processor, a processor, an object, an executable, a thread of execution, a program, and/or a computer, but is not limited thereto. For example, both an application running on a controller and the controller may be components. One or more components may exist within a process and/or thread of execution, and a component may be localized on one computer or distributed between two or more computers.

The above description corresponds to one embodiment for implementing a user-customized information provision system employing an autonomous mobile device according to the present invention. The present invention is not limited to the above embodiment, and as defined in the following claims, the technical spirit of the present invention encompasses various modifications that can be made by those of ordinary skill in the art without departing from the gist of the present invention.

### DESCRIPTION OF SIGNS

100: system for creating virtualized meta-map using spatial data acquired by intelligent indoor autonomous mobile robot
200: autonomous mobile robot or mobility
210: processor
220: memory
230: robot camera
240: lidar sensor
250: autonomous mobile unit
260: communication unit
270: environment information sensor
300: cloud server
310: information collection unit
320: virtual space modeling unit
330: travel information agent unit
340: meta-map generation unit
341: mapping unit
342: synchronization unit
343: target object designation unit
344: movement route generation unit
345: meta-map provision and update unit

1. A system for creating a virtualized meta-map using spatial data acquired by an intelligent indoor autonomous mobile robot, the system comprising:
an autonomous mobile robot or mobility configured to transmit position information of a target object in an indoor space acquired using a visualization sensor during an autonomous travel process; and
a cloud server configured to:
generate, in advance, a virtualized map including object information of the autonomous mobile robot to which overall landscape and object information of the indoor space are mapped;
display the autonomous mobile robot or mobility and position information of the target object in a virtual space;
generate a meta-map reflecting a travel instruction for the autonomous mobile robot or mobility to move to the target object in the virtual space;
convert a virtual space coordinate system in the meta-map into a real-world coordinate system; and
provide information obtained by converting the virtual space coordinate system in the indoor space into the real-world coordinate system to the autonomous mobile robot or mobility,
wherein the autonomous mobile robot or mobility moves to the target object in the indoor space on the basis of the information.

2. The system of claim 1, wherein the cloud server comprises:
an information collection unit configured to collect position information and feature information of a person and/or an object measured during the autonomous travel process of the autonomous mobile robot or mobility and real-world coordinate information of the indoor space in which the autonomous mobile robot or mobility travels from an external server;
a virtual space modeling unit configured to model a three-dimensional (3D) virtual space on indoor coordinates of the indoor space using a digital twin technique;
a travel information agent unit configured to provide the travel instruction for an avatar of the autonomous mobile robot or mobility which is an agent in the virtual space to move to the target object; and
a meta-map generation unit configured to generate a meta-map including the travel instruction for the avatar of the autonomous mobile robot or mobility to move to the target object in the virtual space.

3. The system of claim 2, wherein the meta-map generation unit comprises:
a mapping unit configured to generate a mapping map in which spatial coordinates of the virtual space which is a digital twin space (DTS) generated by the virtual space modeling unit are mapped to spatial coordinates of a real world;
a synchronization unit configured to synchronize position information of the autonomous mobile robot or mobility in the real world on the mapping map with a position of an avatar of the autonomous mobile robot or mobility in the virtual space;
a target object designation unit configured to designate or generate the target object at a position designated by an external terminal in the mapping map;
a movement route generation unit configured to calculate a movement route from the position of the autonomous mobile robot or mobility to the target object in the mapping map and provide the calculated movement route; and
a meta-map provision and update unit configured to generate a meta-map reflecting the movement route generated by the movement route generation unit and reflecting the travel instruction provided by the travel information agent unit in the movement route and transmit the meta-map to the autonomous mobile robot or mobility in the real world,
wherein the meta-map provision and update unit updates the existing meta-map with a meta-map in which a movement route to the target object is recalculated to reflect detection information, which is obtained by detecting an obstacle (moving object) while the autonomous mobile robot or mobility moves along the movement route displayed on the meta-map, in real time and provide the updated meta-map.
